(19) United States
(12) Patent Application Publication
(10) Pub. No.: US 2006/0274490 A1
(43) Pub. Date: Dec. 7, 2006

(54) Notebook computer with an adjustable screen display

(76) Inventor: Steve Cheng, Tao Yuan Shien (TW)

Correspondence Address: RABIN & BERDO, P.C., Suite 500, 1101 14 Street, N.W., Washington, DC, 20005, US

(21) Appl. No.: 11/209,776

(22) Filed: Aug. 24, 2005

(30) Foreign Application Priority Data
Jun. 3, 2005 (TW) 94209331

(51) Int. Cl. G06F 1/16

(52) U.S. Cl. 361/683

(57) ABSTRACT

A notebook computer has a base, a support structure and a screen display. The base has a recess structure mounted on the upper surface of the base. The bottom end of the support structure is pivotally configured in the recess structure. The upper end of the support structure is pivotally configured on the screen display. The screen display may be lifted by the rotation of the support structure relative to the base and/or the screen display. When the screen display of the notebook computer is closed, the support structure is hidden in the recess structure to reduce the size of the notebook computer.

### CROSS-REFERENCE TO RELATED APPLICATION

This application claims the priority benefit of Taiwan application serial No. 94209331, filed Jun. 3, 2005, the full disclosure of which is incorporated herein by reference.

### BACKGROUND

1. Field of Invention

The present invention relates to a notebook computer. More particularly, the present invention relates to a notebook computer with a support structure for adjusting the height between the base of the notebook computer and the screen display of the notebook computer.

2. Description of Related Art

The manufacturing technology of the electrical products has improved along with the advances of technology in recent years. Almost all electrical products need to be light, thin, short, and small, in consideration of the desire of modern people to buy electrical products, which are convenient and easy to use. For example, a notebook computer, a kind of electrical product, is very popular because it is easy to carry and has an excellent ability to process digital information.

The notebook computer, personal data assistant, and any electrical apparatus with a clam shell structure substantially includes a screen display and a base. A hinge is mounted between the screen display and the base to allow the screen display to rotate relative to the base. A user can thus operate the notebook computer easily. Furthermore, when the user operates the notebook computer, the user can read the information from the screen display by adjusting the angle between the screen display and the base.

A notebook computer travels well because it is light, thin, short, and small. However, the height of the screen display cannot be changed easily as the operation environment changes because of the size of the notebook computer. For example, when a notebook computer is positioned on a desk, the height of the screen display of the notebook computer is similar to the height of the screen display of the desktop computer. But when the base of the notebook is positioned on the knee of the user or other plane lower than a desk, the eyes of the user are often higher than the screen display of the notebook computer. Thus, the user can read the information displayed on the screen display of the notebook computer clearly only by, for example, looking down or bending down to the user's discomfort. The height of the screen display is lower and lower as the size of the notebook computer become smaller and smaller. But the height of the conventional notebook computer cannot be adjusted according to the user's requirement.

### SUMMARY

The present invention is directed to a notebook computer with an adjustable screen display, thereby allowing the screen display of the notebook computer to be raised to a height suitable for comfortable use, while keeping the notebook computer light, thin, short, and small.

It is therefore an objective of the present invention to provide a notebook computer with an adjustable screen display for adjusting the height of the screen display as the operation environment changes, without increasing the size of the notebook computer.

It is another an objective of the present invention to provide a support structure for lifting the screen display of the notebook computer to a height comfortable for a user to operate.

In accordance with the foregoing and other objectives of the present invention, the present invention provides a notebook with an adjustable screen display. The notebook computer includes a base, a support structure and a screen display. The base includes a recess structure mounted on the upper surface of the base. The bottom end of the support structure is pivotally configured in the recess structure. The upper end of the support structure is pivotally configured on the screen display. The screen display can be lifted by the rotation of the support structure relative to the base and/or the screen display.

When the screen display of the notebook computer is closed, the support structure is hidden in the recess structure. Thus, the size of the notebook computer of the present invention does not increase.

In conclusion, the invention allows the user adjusts the height and the angle of the screen display when operating the notebook computer of the present invention. Therefore, the user can use the notebook computer comfortably, and thus the injury from improper postures can be avoided.

Moreover, the invention allows the notebook computer to retain its characteristic small size because the extra structure is hidden in the recess structure.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1 is a pictorial view of the notebook when the screen display is opened according to one preferred embodiment of this invention;

FIG. 2 is a side view of the notebook when the screen display is opened according to one preferred embodiment of this invention; and

FIG. 3 is a side view of the notebook when the screen display is lifted according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

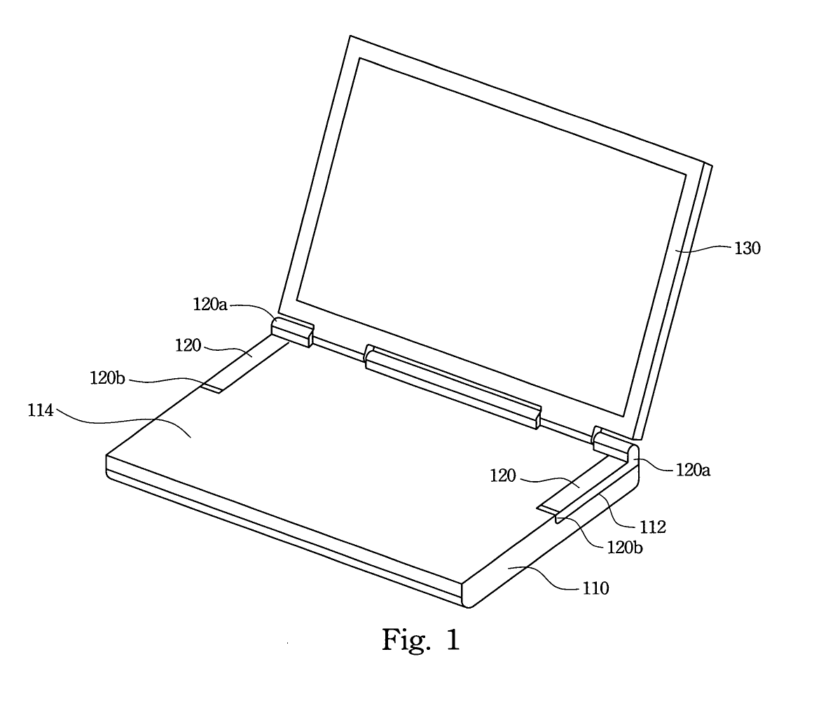

Reference is made to FIG. 1, which is a pictorial view of the notebook according to one preferred embodiment of this invention. The notebook computer of the present invention includes a base 110, a support structure 120, and a screen display 130. The base 110 has a recess structure 112, which is mounted on the both transversal sides of the upper surface 114 of the base 110. The support structure 120 is pivotally configured in the recess structure.

According to this embodiment, the recess structure 112 is two separated alcoves, and the support structure 120 is two separated arm structures. The two separated alcoves are mounted on the left and right sides of the upper surface 114. The upper ends 120a of the two arm structures are pivotally separately configured on the left and right sides of the screen display; the bottom ends 120b of the two arm structures are pivotally configured in the two alcoves dividedly. Furthermore, the support structure 120 is hidden in the recess structure 112 when the screen display 130 of the notebook computer is positioned on the base 110; that is, the screen display 130 of the notebook computer is not lifted.

According to the other embodiment, the support structure can be a flat structure. The upper end of the flat structure is pivotally configured on the screen display. The bottom end of the flat structure is pivotally configured in the recess structure.

Alternatively, the support structure can be a single arm structure. The upper end of the single arm structure is pivotally configured on the screen display. The bottom end of the single arm structure is pivotally configured in the recess structure.

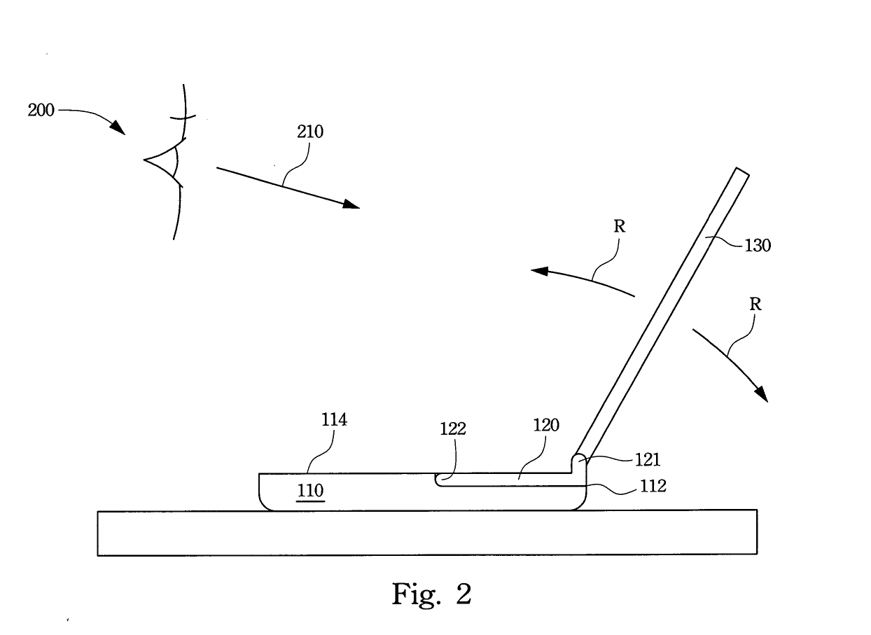

Reference is made to FIG. 2, which is a side view of the notebook when the screen display is opened according to the preferred embodiment of FIG. 1. The support structure 120 has an upper joint 121 and a bottom joint 122. The upper joint 121 is configured between the screen display 130 and the upper end 120a of the support structure 120 (illustrated in FIG. 1) for providing the rotation R of the screen display 130 relative to the support structure 120. The upper joint 121 may have a frictional engagement structure mounted in the upper joint 121 for holding the screen display 130 at an angle relative to the support structure 120.

According to this embodiment, the upper joint 121 is a hinge for allowing the screen display 130 to be swung up about a fixed axis. Alternatively, the upper joint may be a ball-and-socket joint for allowing the screen display 130 to be rotated in three dimensions. Although the rotation R is provided, the screen display 130 is not lifted by the rotation R, and thus a user 200 who operates the notebook computer has to look down at the screen display 130 (as indicated by arrow 210).

As illustrated in FIG. 2, the support structure 120 is hidden in the recess structure 112 when the screen display 130 of the notebook computer is positioned on the base 110; that is, the screen display 130 of the notebook computer is not lifted. The size of the notebook computer does not increase because the extra structure is hidden in the recess structure, and thus the invention allows the notebook computer to remain light, thin, short, and small.

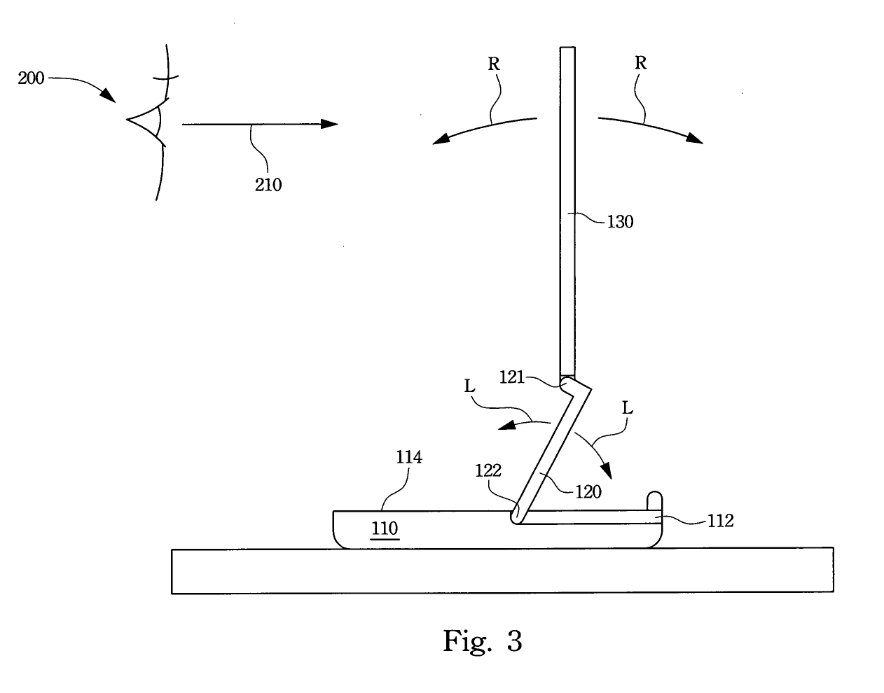

Reference is made to FIG. 3, which is a side view of the notebook when the screen display is lifted according to the preferred embodiment of FIG. 1. The bottom joint 122 is configured between the recess structure 112 and the bottom end 120b of the support structure 120 (illustrated in FIG. 1) for providing the rotation L of the support structure 120 relative to the base 110. The bottom joint 122 may have a frictional engagement structure mounted in the bottom joint 122 for holding the support structure 120 at an angle relative to the base 110.

According to this embodiment, the bottom joint 122 is a hinge for allowing the support structure 120 to be swung up about a fixed axis. Alternatively, the bottom joint may be a ball-and-socket joint for allowing the support structure 120 to be rotated in three dimensions. By providing the rotation L, the screen display 130 is lifted, and thus the user 200 who operates the notebook computer can watch the screen display 130 comfortably (as indicated by arrow 210).

The support structure 120 is a hollow structure and includes a connector in the hollow structure according this preferred embodiment. The connector connects the base 110 to the screen display 130 for transmitting the information of the notebook computer between the base 110 and the screen display 130. Alternatively, the connector may connect the base 110 and the screen display 130 through the outside region of the support structure 120.

In conclusion, the height of the screen display 130 is lifted by the rotation L, and thus the user of the notebook computer can watch the screen display 130 comfortably. Moreover, the support structure 120 is hidden in the recess structure 112 when the screen display 130 of the notebook computer is positioned on the base 110; that is, the screen display 130 of the notebook computer is not lifted. The size of the notebook computer does not increase because the extra structure is hidden in the recess structure 112, and thus the invention allows the notebook computer to remain light, thin, short, and small.

Although the present invention has been described in considerable detail with reference t certain preferred embodiments thereof, other embodiments are possible. Therefore, their spirit and scope of the appended claims should no be limited to the description of the preferred embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A notebook computer, comprising:
a base having an upper surface;
a recess structure mounted on the upper surface of the base;
a support structure having an upper end and a bottom end, wherein the bottom end is pivotally configured in the recess structure; and
a screen display pivotally configured on the upper end of the support structure;
whereby the screen display is lifted by rotation of the support structure relative to the base;
wherein the support structure is hidden in the recess structure when the screen display is closed.

2. The notebook computer of claim 1, wherein the support structure comprises:
a bottom joint configured between the bottom end of the support structure and the recess structure for pivotally connecting the support structure with the base; and
an upper joint configured between the upper end of the support structure and the screen display for pivotally connecting the screen display with the support structure.

3. The notebook computer of claim 2, wherein the bottom joint comprises a frictional engagement structure mounted in the bottom joint for holding the support structure at an angle relative to the base.

4. The notebook computer of claim 2, wherein the upper joint comprises a frictional engagement structure mounted in the upper joint for holding the screen display at an angle relative to the support structure.

5. The notebook computer of claim 2, wherein the bottom joint is a hinge for allowing the support structure to be swung up about a fixed axis.

6. The notebook computer of claim 2, wherein the upper joint is a hinge for allowing the screen display to be swung up about a fixed axis.

7. The notebook computer of claim 2, wherein the bottom joint is a ball-and-socket joint for allowing the support structure to be rotated in three dimensions.

8. The notebook computer of claim 2, wherein the upper joint is a ball-and-socket joint for allowing the screen display to be rotated in three dimensions.

9. The notebook computer of claim 1, wherein the recess structure is a pair of alcoves.

10. The notebook computer of claim 9, wherein the support structure is a pair of arm structures, and the arm structures is allowed to be hidden in the alcoves for reducing the size of the notebook computer.

11. The notebook computer of claim 1, wherein the support structure comprises a connector, and the connector connects the base to the screen display for transmitting information from the notebook computer between the base and the screen display.

12. A support structure connecting a base of a notebook computer with a screen display of the notebook computer for adjusting a height between the screen display and the base, the support structure comprising:
a main structure having an upper end and a bottom end;
a bottom joint configured on the bottom end of the main structure and pivotally connecting the main structure with the base; and
an upper joint configured on the upper end of the main structure and pivotally connecting the main structure with the screen display;
whereby the screen display is lifted by rotation of the main structure relative to the base.

13. The support structure of claim 12, wherein the bottom joint comprises a frictional engagement structure mounted in the bottom joint for holding the main structure at an angle relative to the base.

14. The support structure of claim 12, wherein the upper joint comprises a frictional engagement structure mounted in the upper joint for holding the screen display at an angle relative to the main structure.

15. The support structure of claim 12, wherein the bottom joint is a hinge for allowing the main structure to be swung up about a fixed axis.

16. The support structure of claim 12, wherein the upper joint is a hinge for allowing the screen display to be swung up about a fixed axis.

17. The support structure of claim 12, wherein the bottom joint is a ball-and-socket joint for allowing the main structure to be rotated in three dimensions.

18. The support structure of claim 12, wherein the upper joint is a ball-and-socket joint for allowing the screen display to be rotated in three dimensions.

19. The support structure of claim 12, wherein the notebook computer comprises a recess structure, the bottom joint is pivotally configured in the recess structure, and the main structure is hidden in the recess structure for reducing a size of the notebook computer.

20. The support structure of claim 12, further comprising a connector, wherein the connector connects the base to the screen display for transmitting information from the notebook computer between the base and the screen display.
